(19) United States
(12) Patent Application Publication
(10) Pub. No.: US 2019/0036341 A1
(43) Pub. Date: Jan. 31, 2019

(54) Method for Operation of Energy Storage Systems to Reduce Demand Charges and Increase Photovoltaic (PV) Utilization

(71) Applicant: NEC Laboratories America, Inc., Princeton, NJ (US)

(72) Inventors: Babak Asghari, San Jose, CA (US); Mohammad Rasoul Narimani, Rolla, MO (US); Ratnesh Sharma, Fremont, CA (US)

(21) Appl. No.: 16/006,239

(22) Filed: Jun. 12, 2018

Related U.S. Application Data
(60) Provisional application No. 62/537,303, filed on Jul. 26, 2017.

(51) Int. Cl. H02J 3/38; G05B 19/042; H02J 13/00

(52) U.S. Cl. CPC H02J 3/383; G05B 2219/2639; H02J 13/0006; G05B 19/042

(57) ABSTRACT

A computer-implemented method for controlling a distributed energy storage system (ESS) communicating with one or more microgrids is presented. The method includes assigning, via the processor, a weight to a first objective function pertaining to minimizing demand charge (DC) cost, assigning, via the processor, a weight to a second function pertaining to maximizing photovoltaic (PV) utilization, receiving historical demand profiles including demand data and historical PV profiles including PV data, and determining ESS power and capacity. The method further includes employing a multi-objective DC cost and PV utilization optimization module to obtain a plurality of optimal solutions by concurrently processing the assigned weights of the first and second objective functions, the historical demand and PV profiles, and the ESS power and capacity.

### RELATED APPLICATION INFORMATION

This application claims priority to Provisional Application No. 62/537,303, filed on Jul. 26, 2017, incorporated herein by reference in its entirety.

### BACKGROUND

### Technical Field

The present invention relates to energy management systems and, more particularly, to methods and systems for minimizing demand charge (DC) cost and maximizing local photovoltaic (PV) utilization.

### Description of the Related Art

Distributed renewable energy resources deliver a wide range of benefits to utilities and electricity consumers in terms of economics and sustainability. Electricity consumers can reduce their electricity bills by utilizing solar panels while penetration of these resources can reduce the peak burden on distribution and transmission systems. Beside their benefits, renewable resources have some drawbacks such as intermittency and fluctuations which can be reduced by the use of distributed energy storage systems (ESS). Behind-the-meter (BTM) ESSs have recently come under the spotlight as a possible way to reduce the electricity cost, such as Demand Charge (DC) cost, and level out the fluctuations in renewable energy resources output.

### SUMMARY

A computer-implemented method for controlling a distributed energy storage system (ESS) communicating with one or more microgrids is presented. The method includes assigning, via the processor, a weight to a first objective function pertaining to minimizing demand charge (DC) cost, assigning, via the processor, a weight to a second function pertaining to maximizing photovoltaic (PV) utilization, receiving historical demand profiles including demand data and historical PV profiles including PV data, determining ESS power and capacity, employing a multi-objective DC cost and PV utilization optimization module to obtain a plurality of optimal solutions by concurrently processing the assigned weights of the first and second objective functions, the historical demand and PV profiles, and the ESS power and capacity, and distributing energy to consumers based on the plurality of optimal solutions.

A system for controlling a distributed energy storage system (ESS) communicating with one or more microgrids is also presented. The system includes a memory and a processor in communication with the memory, wherein the processor is configured to assign, via the processor, a weight to a first objective function pertaining to minimizing demand charge (DC) cost, assign, via the processor, a weight to a second function pertaining to maximizing photovoltaic (PV) utilization, receive historical demand profiles including demand data and historical PV profiles including PV data, determine ESS power and capacity, employ a multi-objective DC cost and PV utilization optimization module to obtain a plurality of optimal solutions by concurrently processing the assigned weights of the first and second objective functions, the historical demand and PV profiles, and the ESS power and capacity, and distributing energy to consumers based on the plurality of optimal solutions.

A non-transitory computer-readable storage medium comprising a computer-readable program is presented for controlling a distributed energy storage system (ESS) communicating with one or more microgrids, wherein the computer-readable program when executed on a computer causes the computer to perform the steps of assigning, via the processor, a weight to a first objective function pertaining to minimizing demand charge (DC) cost, assigning, via the processor, a weight to a second function pertaining to maximizing photovoltaic (PV) utilization, receiving historical demand profiles including demand data and historical PV profiles including PV data, determining ESS power and capacity, employing a multi-objective DC cost and PV utilization optimization module to obtain a plurality of optimal solutions by concurrently processing the assigned weights of the first and second objective functions, the historical demand and PV profiles, and the ESS power and capacity, and distributing energy to consumers based on the plurality of optimal solutions.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block/flow diagram illustrating multi-objective optimization to concurrently reduce demand charge (DC) cost and increase photovoltaic (PV) utilization by employing a best compromise solution, in accordance with embodiments of the present invention;

FIG. 2 is a block/flow diagram illustrating demand profiles and PV profiles being processed to assign weighting factors to each day, in accordance with embodiments of the present invention;

FIG. 3 is a block/flow diagram illustrating a decision making model for selecting the best compromise solution, in accordance with embodiments of the present invention;

FIG. 4 is a block/flow diagram illustrating a multi-objective DC cost and PV utilization optimization engine, in accordance with embodiments of the present invention;

FIG. 5 is a block/flow diagram illustrating a method for applying multi-objective optimization to concurrently reduce DC cost and increase PV utilization by employing the best compromise solution, in accordance with embodiments of the present invention;

FIG. 6 is an exemplary processing system for applying multi-objective optimization to concurrently reduce DC cost and increase PV utilization by employing the best compromise solution, in accordance with embodiments of the present invention;

FIG. 7 is a block/flow diagram of an exemplary method for controlling a distributed energy storage system (ESS) communicating with one or more microgrids in Internet of Things (IoT) systems or devices or infrastructure, in accordance with embodiments of the present invention;

FIG. 8 is a block/flow diagram of exemplary IoT sensors used to collect data/information to control a distributed energy storage system (ESS) communicating with one or more microgrids, in accordance with embodiments of the present invention; and

FIG. 9 is a block/flow diagram of a resiliency controller in a microgrid, in accordance with embodiments of the present invention.

### DETAILED DESCRIPTION OF PREFERRED EMBODIMENTS

In the exemplary embodiments of the present invention, methods and devices are presented for controlling distributed energy storage systems (ESSs) to minimize demand charge (DC) cost and to maximize local photovoltaic (PV) utilization for at least commercial and industrial buildings/facilities. Reducing DC cost has a direct impact on customer electricity bills, while increasing local PV utilization can help in the efficient operation of distribution systems. Model-based optimization methods are presented for each individual objective. Furthermore, a multi-objective control strategy can be implemented to illustrate the possibility of stacking both services on a single ESS.

Electricity bills for many Commercial & Industrial (C&I) buildings in the United States and other parts of the world include a Demand Charge (DC) cost. DC is based on the highest 15-minute average usage recorded on a demand meter within a given billing cycle. Demand charges make up a significant portion of commercial and industrial buildings' total electricity costs. DC reduction can be performed by optimal control of ESS without sacrificing the users comfort through curtailing or shifting the loads.

Moreover, a large portion of installed PV systems is concentrated on roofs of residential, commercial, and industrial buildings. Depending on financial incentives, locally produced PV energy can be either self-consumed in the building premises or fed into the grid. High PV utilization ratios in buildings, e.g., the consumption of most of the PV energy within the building premises, can reduce the energy losses in distribution networks, and mitigate overvoltage and transformer overloading. However, maximum PV utilization cannot be achieved without installation and proper control of ESS in the system. As a result, PV utilization has been considered an objective function along with DC cost.

In the exemplary embodiments of the present invention, methods and devices are provided for obtaining an optimal charge/discharge control to achieve both PV utilization and electricity bill reduction by employing an intelligent algorithm. Toward this end, methods and devices are provided for a framework to optimally operate ESS so as to minimize DC cost and maximize PV utilization. In the exemplary embodiments of the present invention, methods and devices are provided for determining an optimal operation of ESS for demand charge management and PV utilization maximization under both single-objective and multi-objective optimization scenarios.

It is to be understood that the present invention will be described in terms of a given illustrative architecture; however, other architectures, structures, substrate materials and process features and steps/blocks can be varied within the scope of the present invention. It should be noted that certain features cannot be shown in all figures for the sake of clarity. This is not intended to be interpreted as a limitation of any particular embodiment, or illustration, or scope of the claims.

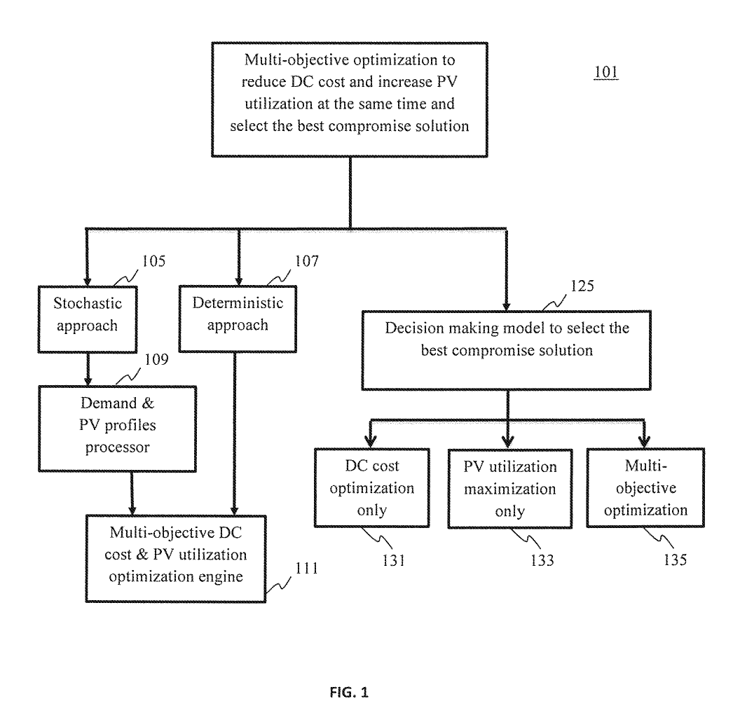

FIG. 1 is a block/flow diagram 101 illustrating multi-objective optimization to concurrently reduce demand charge (DC) cost and increase photovoltaic (PV) utilization by employing a best compromise solution, in accordance with embodiments of the present invention.

The multi-objective optimization approach for reducing DC cost and increasing PV utilization, concurrently, or at the same time, can be accomplished by employing a stochastic approach 105 and a deterministic approach 107. The stochastic approach 105 involves processing demand and PV profiles via a demand and PV processor 109. The deterministic approach 107 involves employing a multi-objective DC cost and PV utilization module or engine 111.

Moreover, the multi-objective optimization approach for reducing DC cost and increasing PV utilization, concurrently, or at the same time, can be accomplished by employing a decision making model 125 to select a best compromise solution. The decision making model 125 can execute only DC cost optimization 131, or only execute PV utilization 133, or execute multi-objective optimization 135 by the multi-objective DC cost and PV utilization module or engine 111.

Two time windows can be considered to calculate DC cost at the end of a billing cycle. These two windows are as follows:

Anytime DC: Defined as the maximum grid power over the entire time horizon.

Peak DC: Defined as the maximum grid power only during the peak time periods of a day. The final DC cost would be the summation of these two components. Time windows and their corresponding rates vary for different seasons. The exemplary electricity tariff which can be used is shown in Table I reproduced below.

TABLE 1
DEMAND CHARGE RATES OF THE SELECTED TARIFF

| | May-October | | November-April | |
|---|---|---|---|---|
| Name | C_{DC}^{Anytime} | C_{DC}^{Peak} | C_{DC}^{Anytime} | C_{DC}^{Peak} |
| Time | Anytime | 11:00-18:00 | Anytime | 17:00-20:00 |
| window | | Mon-Fri | | Mon-Fri |
| Rate ($/kW) | 12.26 | 2.13 | 12.26 | 0.66 |

The DC cost minimization objective function can be written as:

$${F}_{1} = {\sum }_{d = 1}^{{N}_{D}} {\sum }_{i = 1}^{24 / T} {C}_{D C}^{Anytime} \times max ( {P}_{grid}^{Purchase} ( i ) ) + {C}_{D C}^{Peak} \times max ( {P}_{grid}^{Peak} ( i ) ) \qquad ( 1 )$$

Where F₁ is the sum of demand charge cost components.

T is the optimization time-step in hour.

C_{DC}^{Anytime} and C_{DC}^{Peak} are the utility rates for Anytime DC and Peak DC (in $/kW) respectively.

P_{grid}^{Purchase} and P_{grid}^{Peak} are power (in kW) purchased from the grid during Anytime DC and Peak DC time windows, respectively.

N_{D} is the number of days in a billing cycle.

The second objective function is PV utilization maximization. This objective can be optimized by minimizing total sell back of excess PV generation to the grid over a billing cycle (E^{sell}^{_}^{back}) as follows:

$${E}^{sell \_ back} = {\sum }_{d = 1}^{{N}_{D}} {\sum }_{i = 1}^{24 / T} {P}_{grid}^{sell \_ back} ( i , d ) \times T \qquad ( 2 )$$

The improvement in PV utilization through ESS operation is defined as one minus the ratio of E^{sell}^{_}^{back} without any ESS operation to E^{sell}^{_}^{back} with ESS operation as follows:

$${F}_{2} = 1 - \frac{{E}_{with \_ ESS}^{sell \_ back}}{{E}_{Without \_ ESS}^{sell \_ back}} \qquad ( 3 )$$

Constraints of both optimization problems are listed as follows:

SOC^{min}≤SOC(i)≤SOC^{max} (4)

SoC(i+1)=SoC(i)−αP_{b}^{dischg}(i)+αμP_{b}^{chg}(i) (5)

P_{b}^{chg}(i),P_{b}^{dischg}(i)≤P_{b}^{max} (6)

P_{grid}^{Purchase}(i)−P_{grid}^{Sell}^{_}^{back}(i)−P_{b}^{chg}(i)+P_{b}^{dischg}(i)=P_{d}(i)−P_{PV}(i) (7)

Equation (4) defines the State of Charge (SoC) limits, where SoC^{min} and SoC^{max} are the lower and upper bounds of ESS SoC, respectively.

Equation (5) defines the SoC based on energy stored in the ESS at the previous time-step and charge/discharge powers at each time-step, where α is a coefficient to convert kW to Ah, and μ is the roundtrip efficiency.

P_{b}^{chg} and P_{b}^{dischg} are ESS charge and discharge powers (in kW), respectively.

Equation (6) ensures both ESS charge and discharge powers are always less than maximum ESS power (P_{b}^{max}).

Equation (7) expresses the Supply-Demand balance in the system, where

P_{grid}^{Sell}^{_}^{back}(i),P_{d}(i), and P_{PV}(i)

Where (i) are the sell back power to the grid, the active demand power, and the PV output power at i^{th} time interval, respectively.

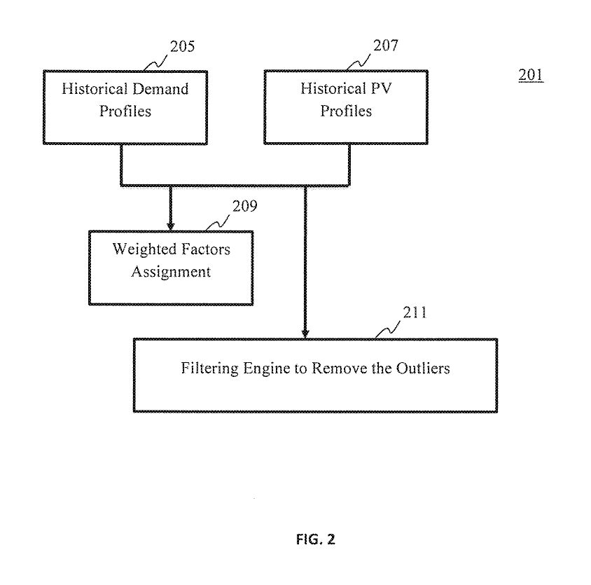

FIG. 2 is a block/flow diagram 201 illustrating demand profiles and PV profiles being processed to assign weighting factors to each day, in accordance with embodiments of the present invention.

The historical demand profiles 205 and the historical PV profiles 207 are employed with the weighted factors assignment 209 and fed into the filtering engine 211 to remove outliers.

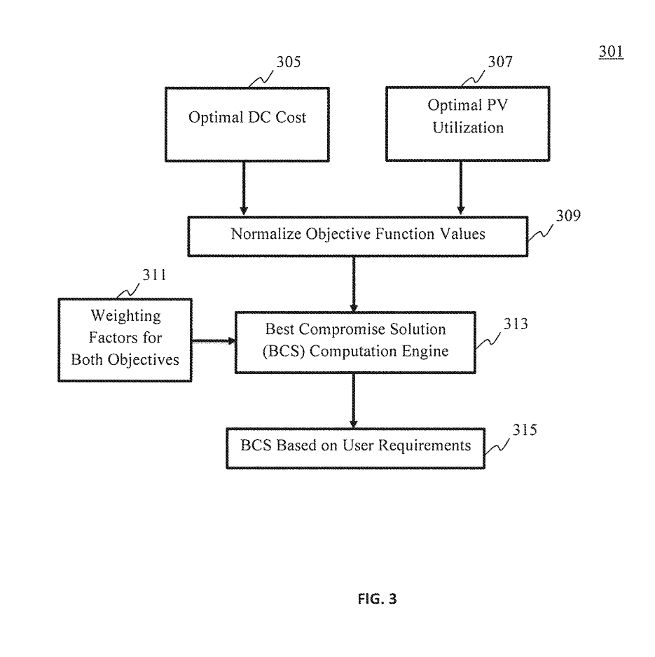

FIG. 3 is a block/flow diagram 301 illustrating a decision making model for selecting the best compromise solution, in accordance with embodiments of the present invention.

The optimal DC cost 305 and the optimal PV utilization 307 are normalized via the normalization module 309. The normalized values and the weighting factors 311 for both objective functions are fed into the best compromise solution computation engine 313. The best compromise solution is based on user requirements 315.

Therefore, the decision making model can be processed to calculate the best compromise solution based on user requirements. The weighting factors are selected by users based on certain user requirements. The objective function can be normalized, before going into the decision making process, in order to acquire a same range. The decision making process applies the weighting factor to normalize the objective function in order to compute the best compromise solution (BCS).

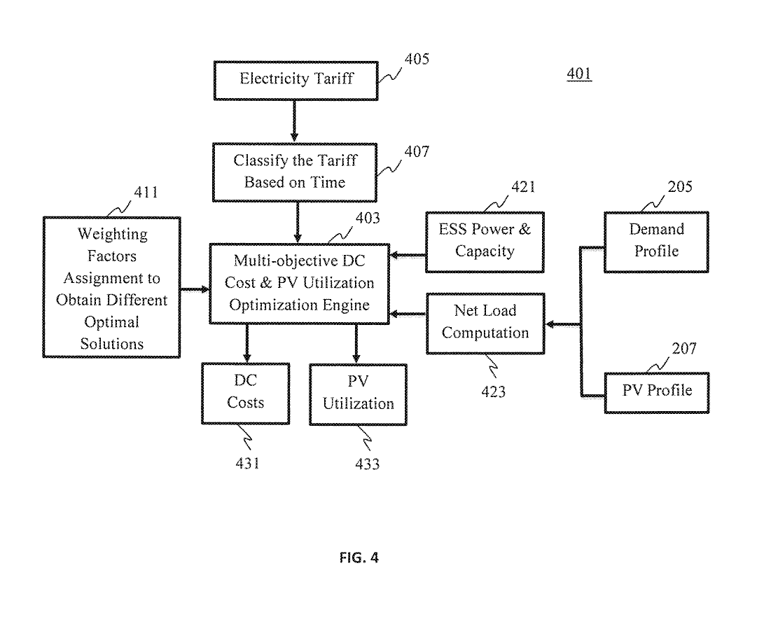

FIG. 4 is a block/flow diagram 401 illustrating a multi-objective DC cost and PV utilization optimization engine, in accordance with embodiments of the present invention.

In order to determine the DC costs 431 and the PV utilization 433, a multi-objective DC cost and PV utilization optimization module or engine 403 is employed. The DC cost and PV utilization optimization module or engine 403 processes electricity tariffs 405, assigned weighting factors 411 for obtaining different optimal solutions, ESS power and capacity 421, and net load computations 423. The electricity tariffs 405 can be classified by a classification module 407 based on, e.g., time. The net load computation 423 can be employed to handle the historical demand profiles 205 and the historical PV profiles 207.

Therefore, the weighting factors are assigned to determine the importance of each objective function. Then the demand profile, the weighting factors, and ESS power and capacity are sent into the multi-objective DC cost & PV utilization optimization module or engine 403.

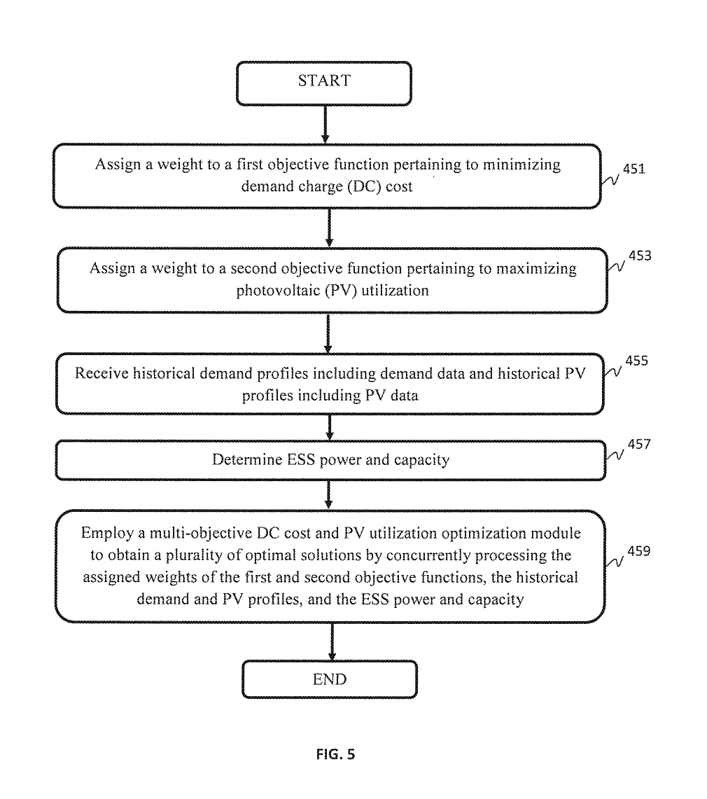

FIG. 5 is a block/flow diagram illustrating a method for controlling a distributed energy storage system (ESS) communicating with one or more microgrids, in accordance with embodiments of the present invention.

At block 451, a weight is assigned to a first objective function pertaining to minimizing demand charge (DC) cost.

At block 453, a weight is assigned to a second objective function pertaining to maximizing photovoltaic (PV) utilization.

At block 455, historical demand profiles including demand data and historical PV profiles including PV data are received for processing.

At block 457, ESS power and capacity is determined.

At block 459, a multi-objective DC cost and PV utilization optimization module is employed to obtain a plurality of optimal solutions by concurrently processing the assigned weights of the first and second objective functions, the historical demand and PV profiles, and the ESS power and capacity.

In summary, the exemplary embodiments of the present invention disclose an optimal strategy for control of Energy Storage Systems (ESSs) to minimize Demand Charge (DC) cost, by shaving peak demand for Commercial and Industrial (C&I) customers, and maximize local PV utilization at the same time for C&I buildings. A multi-objective control strategy is introduced to illustrate the possibility of stacking both services on a single ESS.

The exemplary embodiments of the present invention apply the weighted sum method to obtain a plurality of optimal solutions. The proposed method optimizes the charging and discharging schedules of ESS to decrease the demand charge and increase the PV utilization at the same time or concurrently. Different optimal solutions can be obtained by changing the weighting factor of objective functions. A decision making process selects the best compromise solution based on user requirements.

The exemplary embodiments of the present invention reduce electricity bills for commercial and industrial users by decreasing demand charge cost for these users. Furthermore, the exemplary embodiments of the present invention decrease the energy losses in distribution networks, and mitigate overvoltage and transformer overloading, by increasing the PV utilization. Moreover, different optimal solutions can be obtained by a decision making process to select the best compromise solution based on the user requirements.

The exemplary embodiments of the present invention further employ a weighted sum optimization method to optimize DC cost and PV utilization. The weighted sum optimization method dedicates a weight to each objective function in order to determine its importance. Then the weighted sum optimization method considers all objective functions at the same time or concurrently by summation of all objective functions multiplied by their corresponding weight factors. The exemplary embodiments of the present invention further employ a decision making model to select the best compromise solution. The multi-objective optimization has a plurality of optimal solutions in which the user selects one based on his/her requirements. The decision making model helps users to accomplish such task by defining the weighting factors based on certain user requirements. The exemplary embodiments of the present invention further employ a Best Compromise Solution (BCS) computation engine. The BCS computation engine receives the normalized objective function values, as well as the weight factors for each objective. Then for each set of optimal solutions, the objective value gets multiplied by the corresponding weight factor. Then after all obtained values are normalized, the BCS can be computed.

The exemplary embodiments of the present invention further employ the multi-objective optimization engine, data processing method, and decision making process. The multi-objective optimization engine takes the PV utilization into account along with the DC management, the data processing method filters the outliers to make the process more accurate, and the decision making process utilizes the predetermined weight factors to obtained the best compromise solution.

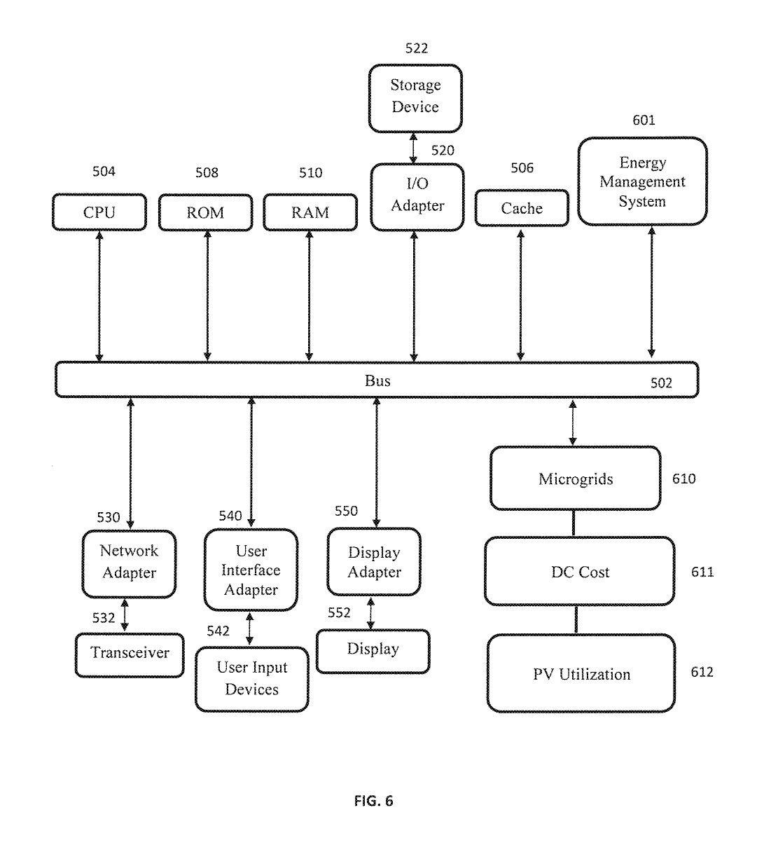

FIG. 6 is an exemplary processing system for controlling a distributed energy storage system (ESS) communicating with one or more microgrids, in accordance with embodiments of the present invention.

The processing system includes at least one processor (CPU) 504 operatively coupled to other components via a system bus 502. A cache 506, a Read Only Memory (ROM) 508, a Random Access Memory (RAM) 510, an input/output (I/O) adapter 520, a network adapter 530, a user interface adapter 540, and a display adapter 550, are operatively coupled to the system bus 502. Additionally, an energy management system 601 is operatively coupled to the system bus 502. The energy management system 601 includes microgrids 610 in which an ESS minimizes DC cost 611 and increases PV utilization 612.

A storage device 522 is operatively coupled to system bus 502 by the I/O adapter 520. The storage device 522 can be any of a disk storage device (e.g., a magnetic or optical disk storage device), a solid state magnetic device, and so forth.

A transceiver 532 is operatively coupled to system bus 502 by network adapter 530.

User input devices 542 are operatively coupled to system bus 502 by user interface adapter 540. The user input devices 542 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present invention. The user input devices 542 can be the same type of user input device or different types of user input devices. The user input devices 542 are used to input and output information to and from the processing system.

A display device 552 is operatively coupled to system bus 502 by display adapter 550.

Of course, the energy management processing system may also include other elements (not shown), as readily contemplated by one of skill in the art, as well as omit certain elements. For example, various other input devices and/or output devices can be included in the system, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the energy management processing system are readily contemplated by one of ordinary skill in the art given the teachings of the present invention provided herein.

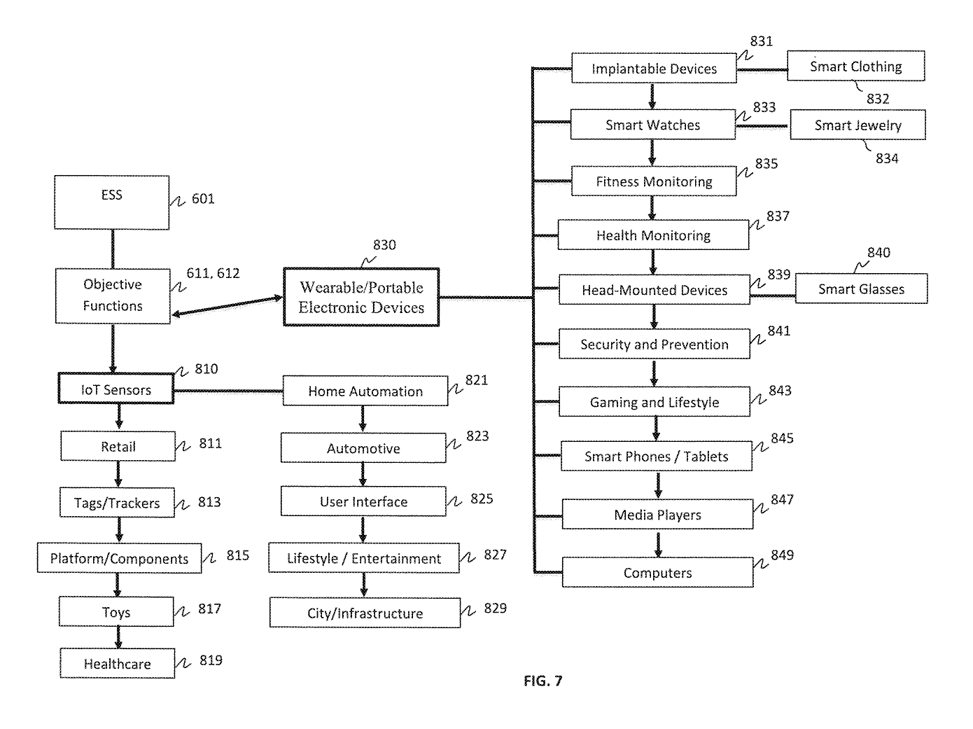

FIG. 7 is a block/flow diagram of a method for controlling a distributed energy storage system (ESS) communicating with one or more microgrids in Internet of Things (IoT) systems or devices or infrastructure, in accordance with embodiments of the present invention.

According to some exemplary embodiments of the invention, an energy management system is implemented using an IoT methodology, in which a large number of ordinary items are utilized in the vast infrastructure of an energy management system.

IoT enables advanced connectivity of computing and embedded devices through internet infrastructure. IoT involves machine-to-machine communications (M2M), where it is important to continuously monitor connected machines to detect any anomaly or bug, and resolve them quickly to minimize downtime.

The energy management system or ESS 601 (and objective functions 611, 612) can communicate with, e.g., wearable, implantable, or ingestible electronic devices and Internet of Things (IoT) sensors. The wearable, implantable, or ingestible devices can include at least health and wellness monitoring devices, as well as fitness devices. The wearable, implantable, or ingestible devices can further include at least implantable devices, smart watches, head-mounted devices, security and prevention devices, and gaming and lifestyle devices. The IoT sensors can be incorporated into at least home automation applications, automotive applications, user interface applications, lifestyle and/or entertainment applications, city and/or infrastructure applications, toys, healthcare, fitness, retail tags and/or trackers, platforms and components, etc. The energy management system or ESS 601 described herein can communicate with any type of electronic devices for any type of use or application or operation.

IoT (Internet of Things) is an advanced automation and analytics system which exploits networking, sensing, big data, and artificial intelligence technology to deliver complete systems for a product or service. These systems allow greater transparency, control, and performance when applied to any industry or system.

IoT systems have applications across industries through their unique flexibility and ability to be suitable in any environment. IoT systems enhance data collection, automation, operations, and much more through smart devices and powerful enabling technology.

IoT systems allow users to achieve deeper automation, analysis, and integration within a system. IoT improves the reach of these areas and their accuracy. IoT utilizes existing and emerging technology for sensing, networking, and robotics. Features of IoT include artificial intelligence, connectivity, sensors, active engagement, and small device use. In various embodiments, the energy management system or ESS 601 of the present invention can communicate with a variety of different devices and/or systems. For example, the energy management system or ESS 601 can communicate with wearable or portable electronic devices 830. Wearable/portable electronic devices 830 can include implantable devices 831, such as smart clothing 832. Wearable/portable devices 830 can include smart watches 833, as well as smart jewelry 834. Wearable/portable devices 830 can further include fitness monitoring devices 835, health and wellness monitoring devices 837, head-mounted devices 839 (e.g., smart glasses 840), security and prevention systems 841, gaming and lifestyle devices 843, smart phones/tablets 845, media players 847, and/or computers/computing devices 849.

The energy management system 601 of the present invention can further communicate with Internet of Thing (IoT) sensors 810 for various applications, such as home automation 821, automotive 823, user interface 825, lifestyle and/or entertainment 827, city and/or infrastructure 829, retail 811, tags and/or trackers 813, platform and components 815, toys 817, and/or healthcare 819. Of course, one skilled in the art can contemplate such energy management system 601 communicating with any type of electronic devices for any types of applications, not limited to the ones described herein.

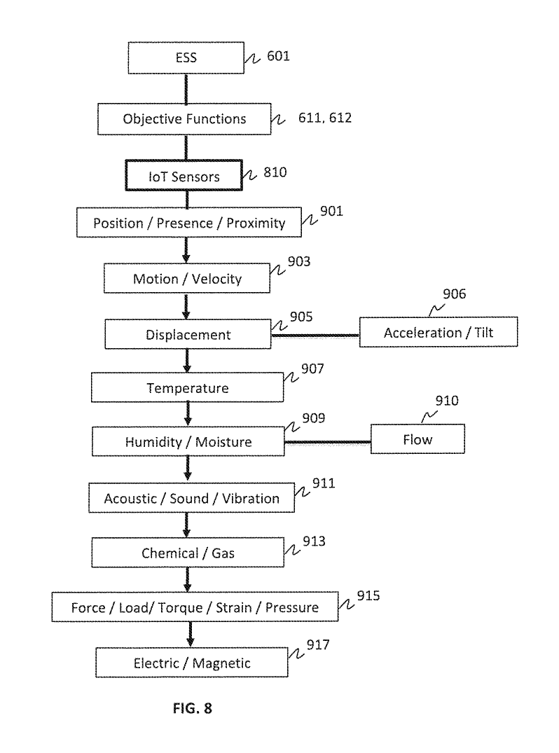

FIG. 8 is a block/flow diagram of exemplary IoT sensors used to collect data/information to control a distributed energy storage system (ESS) communicating with one or more microgrids, in accordance with embodiments of the present invention.

IoT loses its distinction without sensors. IoT sensors act as defining instruments which transform IoT from a standard passive network of devices into an active system capable of real-world integration.

The IoT sensors 810 can be connected via the ESS 601 to transmit information/data, continuously and in in real-time. Exemplary IoT sensors 810 can include, but are not limited to, position/presence/proximity sensors 901, motion/velocity sensors 903, displacement sensors 905, such as acceleration/tilt sensors 906, temperature sensors 907, humidity/moisture sensors 909, as well as flow sensors 910, acoustic/sound/vibration sensors 911, chemical/gas sensors 913, force/load/torque/strain/pressure sensors 915, and/or electric/magnetic sensors 917. One skilled in the art can contemplate using any combination of such sensors to collect data/information and input into the modules 610, 611, 612 of the energy management system or ESS 601 for further processing. One skilled in the art can contemplate using other types of IoT sensors, such as, but not limited to, magnetometers, gyroscopes, image sensors, light sensors, radio frequency identification (RFID) sensors, and/or micro flow sensors. IoT sensors can also include energy modules, power management modules, RF modules, and sensing modules. RF modules manage communications through their signal processing, WiFi, ZigBee®, Bluetooth®, radio transceiver, duplexer, etc.

Moreover data collection software can be used to manage sensing, measurements, light data filtering, light data security, and aggregation of data. Data collection software uses certain protocols to aid IoT sensors in connecting with real-time, machine-to-machine networks. Then the data collection software collects data from multiple devices and distributes it in accordance with settings. Data collection software also works in reverse by distributing data over devices. The system can eventually transmit all collected data to, e.g., a central server.

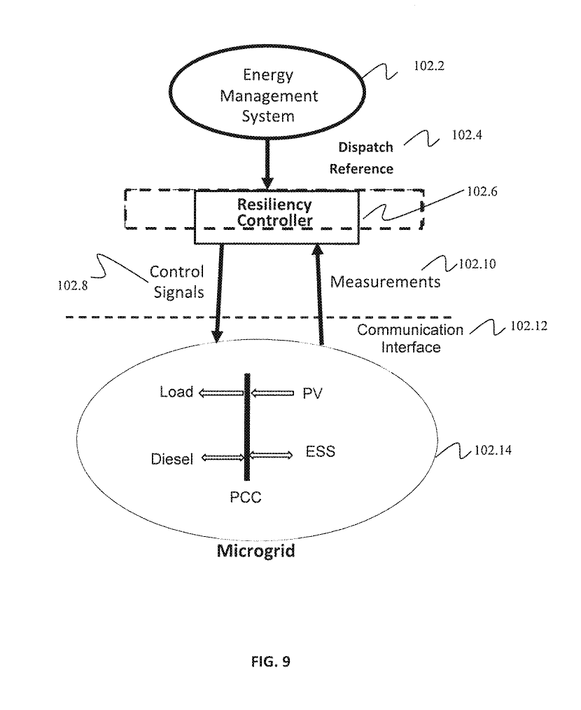

FIG. 9 is a block/flow diagram of a resiliency controller in a microgrid, in accordance with embodiments of the present invention.

In FIG. 9, 102.2 is the energy management system, which sends out the active power dispatch reference 102.4 of each distributed generator (DG) in a microgrid 102.14 to the resiliency controller 102.6. Meanwhile, the resiliency controller 102.6 collects the measurement data 102.10 from the microgrid 102.14 through a communication interface 102.12. Based on the dispatch reference 102.4 and measurement data 102.10, the resiliency controller 102.6 sends out the control signals 102.8 to the Distributed Generators (DGs) in the microgrid 102.14 through the same communication interface 102.12.

Regarding 102.2, the Energy Management System is in charge of the economic operation of the microgrid. The Energy Management System needs to realize functions such as unit commitment, economic dispatch, renewable forecasting, etc. The Energy Management System sends out active power dispatch references to the resiliency controller 102.6 for each DG in the microgrid 102.14.

Regarding 102.14, the DGs in the microgrid can be divided into at least three categories:

C1: Battery Energy Storage System (ESS);

C2: Traditional generators using fossil fuels, such as the diesel generator;

C3: Renewable generators, such as PV and Wind;

DGs in C1 and C2 are equipped with droop control in their local controllers. DGs' output active power is related to the microgrid frequency, while DGs' output reactive power is related to the microgrid voltage.

DGs in C3 are equipped with Maximum Power Point Tracking (MPPT) algorithm to harvest the maximum amount of energy under the given weather condition. Meanwhile, they can also be equipped with droop control in their local controllers.

The resiliency controller 102.6 includes multiple functional modules to control the DGs in the microgrid 102.14 utilizing system-level information.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical data storage device, a magnetic data storage device, or any suitable combination of the foregoing. In the context of this document, a computer readable storage medium may be any tangible medium that can include, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the present invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks or modules.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks or modules.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks or modules.

It is to be appreciated that the term “processor” as used herein is intended to include any processing device, such as, for example, one that includes a CPU (central processing unit) and/or other processing circuitry. It is also to be understood that the term “processor” may refer to more than one processing device and that various elements associated with a processing device may be shared by other processing devices.

The term “memory” as used herein is intended to include memory associated with a processor or CPU, such as, for example, RAM, ROM, a fixed memory device (e.g., hard drive), a removable memory device (e.g., diskette), flash memory, etc. Such memory may be considered a computer readable storage medium.

In addition, the phrase “input/output devices” or “I/O devices” as used herein is intended to include, for example, one or more input devices (e.g., keyboard, mouse, scanner, etc.) for entering data to the processing unit, and/or one or more output devices (e.g., speaker, display, printer, etc.) for presenting results associated with the processing unit.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method executed on a processor for controlling a distributed energy storage system (ESS) communicating with one or more microgrids, the method comprising:
assigning, via the processor, a weight to a first objective function pertaining to minimizing demand charge (DC) cost;
assigning, via the processor, a weight to a second function pertaining to maximizing photovoltaic (PV) utilization;
receiving historical demand profiles including demand data and historical PV profiles including PV data;
determining ESS power and capacity;
employing a multi-objective DC cost and PV utilization optimization module to obtain a plurality of optimal solutions by concurrently processing the assigned weights of the first and second objective functions, the historical demand and PV profiles, and the ESS power and capacity; and
distributing energy to consumers based on the plurality of optimal solutions.

2. The method of claim 1, further comprising optimizing a charging and discharging schedule of the ESS to concurrently decrease DC cost and increase PV utilization.

3. The method of claim 2, further comprising adjusting a weight factor of the first and second objective functions to obtain different optimal solutions.

4. The method of claim 2, further comprising employing a best compromise solution computation module to select a single optimal solution from the plurality of optimal solutions based on user requirements.

5. The method of claim 4, further comprising normalizing the assigned weights of the first and second objective functions before being processed by the best compromise solution computation module.

6. The method of claim 1, further comprising applying a filtering module to the assigned weights of the first and second objective functions to remove outliers.

7. The method of claim 1, further comprising supplying electricity tariff requirements to the multi-objective DC cost and PV utilization optimization module.

8. A system for controlling a distributed energy storage system (ESS) communicating with one or more microgrids, the system comprising:
a memory; and
a processor in communication with the memory, wherein the processor runs program code to:
assign, via the processor, a weight to a first objective function pertaining to minimizing demand charge (DC) cost;
assign, via the processor, a weight to a second function pertaining to maximizing photovoltaic (PV) utilization;
receive historical demand profiles including demand data and historical PV profiles including PV data;
determine ESS power and capacity;
employ a multi-objective DC cost and PV utilization optimization module to obtain a plurality of optimal solutions by concurrently processing the assigned weights of the first and second objective functions, the historical demand and PV profiles, and the ESS power and capacity; and
distribute energy to consumers based on the plurality of optimal solutions.

9. The system of claim 8, wherein a charging and discharging schedule of the ESS is optimized to concurrently decrease DC cost and increase PV utilization.

10. The system of claim 9, wherein a weight factor of the first and second objective functions is adjusted to obtain different optimal solutions.

11. The system of claim 9, wherein a best compromise solution computation module is employed to select a single optimal solution from the plurality of optimal solutions based on user requirements.

12. The system of claim 11, wherein the assigned weights of the first and second objective functions are normalized before being processed by the best compromise solution computation module.

13. The system of claim 8, wherein a filtering module is applied to the assigned weights of the first and second objective functions to remove outliers.

14. The system of claim 8, wherein electricity tariff requirements are supplied to the multi-objective DC cost and PV utilization optimization module.

15. A non-transitory computer-readable storage medium comprising a computer-readable program for controlling a distributed energy storage system (ESS) communicating with one or more microgrids, wherein the computer-readable program when executed on a computer causes the computer to perform the steps of:
assigning, via the processor, a weight to a first objective function pertaining to minimizing demand charge (DC) cost;
assigning, via the processor, a weight to a second function pertaining to maximizing photovoltaic (PV) utilization;
receiving historical demand profiles including demand data and historical PV profiles including PV data;
determining ESS power and capacity;
employing a multi-objective DC cost and PV utilization optimization module to obtain a plurality of optimal solutions by concurrently processing the assigned weights of the first and second objective functions, the historical demand and PV profiles, and the ESS power and capacity; and
distributing energy to consumers based on the plurality of optimal solutions.

16. The non-transitory computer-readable storage medium of claim 15, wherein a charging and discharging schedule of the ESS is optimized to concurrently decrease DC cost and increase PV utilization.

17. The non-transitory computer-readable storage medium of claim 16, wherein a weight factor of the first and second objective functions is adjusted to obtain different optimal solutions.

18. The non-transitory computer-readable storage medium of claim 16, wherein a best compromise solution computation module is employed to select a single optimal solution from the plurality of optimal solutions based on user requirements.

19. The non-transitory computer-readable storage medium of claim 18, wherein the assigned weights of the first and second objective functions are normalized before being processed by the best compromise solution computation module.

20. The non-transitory computer-readable storage medium of claim 15, wherein a filtering module is applied to the assigned weights of the first and second objective functions to remove outliers.
